(19) United States
(12) Patent Application Publication
(10) Pub. No.: US 2005/0152283 A1
(43) Pub. Date: Jul. 14, 2005

(54) Wireless device discovery

(76) Inventor: David Ritzenthaler, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/754,659

(22) Filed: Jan. 8, 2004

(51) Int. Cl. H04L 12/28

(52) U.S. Cl. 370/254; 370/338; 370/252

(57) ABSTRACT

Methods and apparatus for discovering wireless peripheral devices utilizing wireless broadcasts at multiple power levels. A first data packet containing identification information associated with the wireless device is broadcast by that wireless device. The identification information contains at least a location and a functionality of the wireless device. After broadcasting the first data packet, the wireless device broadcasts a second data packet a plurality of times. A first occurrence of the second data packet is broadcast at a first power level and a second occurrence of the second data packet is broadcast at a second power level lower than the first power level. Additional broadcasts at diminishing power levels can further be utilized. Relative proximity of the broadcasting wireless device can be determined based on the lowest power level received from the device.

### TECHNICAL FIELD OF THE INVENTION

The present invention relates generally to discovering wireless network devices within a wireless network and determination of their relative proximity.

### BACKGROUND OF THE INVENTION

As networks of computing devices and peripherals become more complex and dynamic, it becomes increasingly important for the network structure to be flexible and to be easily updated. To address this challenge, wireless networks have become increasingly popular. Because device additions to a wireless network do not require the addition or rerouting of physical cabling, they are generally more flexible and easily updated than are wired networks. Wireless networks further have the advantage of being able to accommodate transient or mobile users.

One dilemma a network user may face is locating a computer peripheral the user may wish to use. As an example, a wireless network user may want to print out a color document from their palmtop computer. The user would want to locate a color printer reasonably close to their current location.

For the reasons stated above, and for other reasons stated below that will become apparent to those skilled in the art upon reading and understanding the present specification, there is a need in the art for alternative methods for discovering wireless devices.

### SUMMARY

The various embodiments facilitate discovery of wireless peripheral devices using a beacon of diminishing power broadcast by the wireless peripheral device. Examples of wireless peripheral devices include imaging devices, such as printers, plotters, multi-function devices, etc. for producing tangible output of image data. A first data packet containing identification information associated with the wireless device is broadcast by that wireless device. The identification information contains at least a location and a functionality of the wireless device After broadcasting the first data packet, the wireless device broadcasts a second data packet a plurality of times. A first occurrence of the second data packet is broadcast at a first power level and a second occurrence of the second data packet is broadcast at a second power level lower than the first power level. Additional broadcasts at diminishing power levels can further be utilized. Relative proximity of the broadcasting wireless device can be determined based on the lowest power level received from the device.

Further embodiments of the invention include apparatus and methods of varying scope.

### BRIEF DESCRIPTION OF THE DRAWINGS

FIG. 1 is a schematic of a typical wireless network containing one or more wireless network peripheral devices and one or more wireless network client devices, in accordance with an embodiment of the invention.

FIG. 2A is a flowchart for a method of operating a wireless device, in accordance with one embodiment of the invention.

FIG. 2B is a flowchart for a method of operating a wireless device, in accordance with another embodiment of the invention.

FIG. 3 is a schematic of a wireless network containing one or more wireless network peripheral devices and a wireless network client device, in accordance with an embodiment of the invention.

FIG. 4 is a flowchart for a method of operating a client device, in accordance with an embodiment of the invention.

FIG. 5 is a block diagram of a wireless peripheral device and a client device, in accordance with an embodiment of the invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

Certain embodiments provide methods of determining a relative proximity of a network device to a user based on a number of times a repeated sentence, or packet, is received from the network device by the user to a number of times the packet is expected to be received. The network device transmits the packet using a beacon of diminishing signal strength. That is, the network device transmits the packet repeatedly at differing and diminishing power levels. Based, at least in part, on the number of times the repeated packet is received, and thus the lowest power level at which the repeated packet is received, a user can prioritize devices based on relative proximity. Additional embodiments provide methods of prioritizing peripheral devices based on other factors, such as device functionalities or longitudinal quality, i.e., quality over time, of the received beacon.

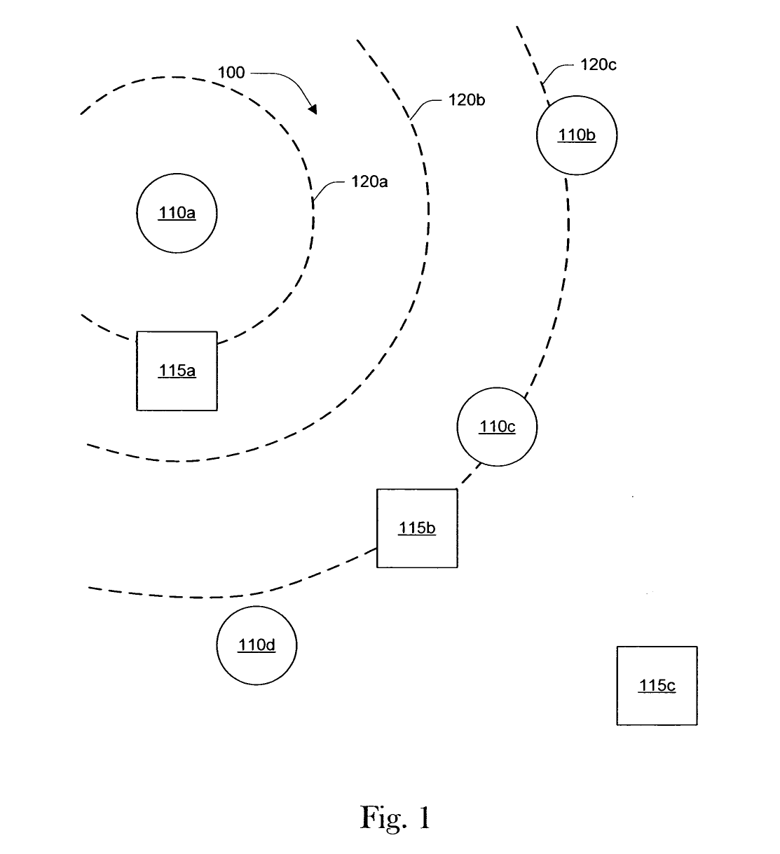

FIG. 1 is a schematic of a wireless network 100 containing one or more wireless network peripheral devices 110 (110a-110d) and one or more wireless network client devices 115 (115a-115c). Wireless communications include radio frequency (RF) communications, infrared (IR) communications, microwave communications and other techniques for communicating between devices without the need for a physical connection.

Some examples of the wireless peripheral devices 110 include imaging devices, e.g., printers, facsimile machines, plotters and other devices for producing an image, whether single or multi-function devices. Some examples of wireless client devices 115 include personal digital assistants (PDAs) and other handheld devices, laptops, workstations, servers, etc. One or more of the wireless peripheral devices 110 is adapted to perform methods of the invention and/or one or more of the wireless client devices 115 is adapted to perform methods of the invention.

The wireless network 100 may contain other devices, such as wireless gateways (not shown). The wireless gateways can act as a relay within the wireless network 100 to facilitate communication between two network devices 110 that are not within range of each other. However, the wireless network devices 110 are capable of direct, or peer-to-peer, communications between each other, albeit at a reduced communication range.

In a wireless network 100, data travels between wireless devices substantially in a straight line. Generally, higher signal strengths equate to larger transmission distances. Conversely, a receiving device must generally be closer to the transmitting device if the signal strength is reduced. As an example, dashed lines 120c, 120b and 120a represent transmission distances for the peripheral device 110a transmitting at a first power level, a second power level less than the first power level, and a third power level less than the second power level, respectively. It is expected that the client device 115a would be able to receive a beacon from the peripheral device 110a transmitting at either the first, second or third power levels. It is further expected that the client device 115b would be able to receive the beacon from the peripheral device 110a transmitting at the first power level, but not if the peripheral device 110a is transmitting at the second or third power levels. It is still further expected that the client device 115c would not be able to receive the beacon from the peripheral device 110a transmitting at any of the foregoing power levels.

The various embodiments facilitate discovery of wireless devices by having the device transmit a beacon containing identification information transmitted at an initial power level followed by repeated packets at diminishing power levels. That is, the repeated packet of information is transmitted, for example, at a first power level, then a second power level less than the first power level, then a third power level less than the second power level, etc. While it is generally preferred that each device in the wireless network transmitting a beacon, in accordance with the invention, utilize the same number of repetitions and the same power levels, the identification information may contain information designating the number of times it will transmit the repeated packet and the power level of each transmission.

Generally, the identification portion contains information associated with the peripheral device that will be relevant to a user searching for available and suitable devices. The identification portion is preferably transmitted at a power level that equals or exceeds a power level used to transmit the first occurrence of the repeated portion. In this manner, it is presumed that a user will not receive an occurrence of the repeated portion unless they also receive the identification portion.

The following is an example of the format for a data packet containing identification information associated with a peripheral device. Each portion of the data packet may represent a string of set length, e.g., 32 bits. For one embodiment, one or more strings may represent a description of the peripheral device meaningful to a user, e.g., Hewlett-Packard LaserJet 2100 Msi. In general, each ASCII character requires one byte, or eight bits, of information such that the foregoing 32-character description would require eight 32-bit strings. It is recognized that other string lengths could be used. It is further recognized that limits could be placed on the available characters in the device description to reduce data transmission requirements.

For a further embodiment, one or more strings may represent functionality. As an example, each bit of the string may be a yes/no flag to indicate whether or not the peripheral device has certain functionality, such as collating, stapling, color output, etc. Alternatively, or additionally, groupings of bits may be used to indicate functionality where a yes/no flag provides insufficient information. That is, a grouping of two bits could be used to indicate a functionality having up to four values, a grouping of three bits could be used to indicate a functionality having up the eight values and so on.

For a still further embodiment, one or more strings may represent location information in a format meaningful to a user. This location information may be provided in more than one level of granularity. For example, a macro location, i.e., a general area where the peripheral is located, could be provided along with a micro location, i.e., a specific location within the general area where the peripheral is located. To continue with the example, the first location information may indicate a building and floor containing the peripheral device while the second location information might indicate a specific office or individual associated with the device.

Additionally, one or more strings may represent permissions associated with the device, i.e., what level of authorization might be required to access the device. While a device may be transmitting and within range, a user would want to ignore the device if the lack the necessary permissions to utilize it. Finally, the data packet could contain a check sum for error checking algorithms.

Following transmission of the identification portion, the peripheral device will transmit one or more additional strings at diminishing power levels. The additional strings are preferably identical. The content of the repeated portion is not important and may be either whimsical or informative. As an example, the sentence “My dog is named Haribo” could be transmitted first at a first power level, e.g., 400 mW, then again at a second power level, e.g., 300 mW, then again at a third power level, e.g., 200 mW, then again at a fourth power level, e.g., 100 mW, then again at a fifth power level, e.g., 50 mW, and finally again at a sixth power level, e.g., 10 mW. Alternatively, each repeated string could vary in a predetermined manner. As an example, the sentence “Transmission at 400 mW” could be transmitted at a first power level, e.g., 400 mW, then the sentence “Transmission at 300 mW” could be transmitted at a second power level, e.g., 300 mW, then the sentence “Transmission at 200 mW” could be transmitted at a third power level, e.g., 200 mW, then the sentence “Transmission at 100 mW” could be transmitted at a fourth power level, e.g., 100 mW, then the sentence “Transmission at 50 mW” could be transmitted at a fifth power level, e.g., 50 mW, and finally the sentence “Transmission at 10 mW” could be transmitted at a sixth power level, e.g., 10 mW. Where the identification portion or the repeated portion provides an indication of the transmission power level of each occurrence, the value of the lowest received power level for a device can be used as an indication of its relative proximity. It is recognized that broadcasting devices may result in “collisions” of transmitted data packets. However, coping with and resolving data collisions within wired and wireless networks is well known and will not be dealt with herein.

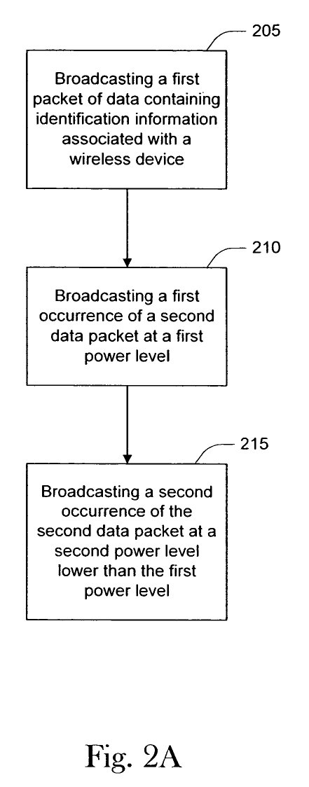

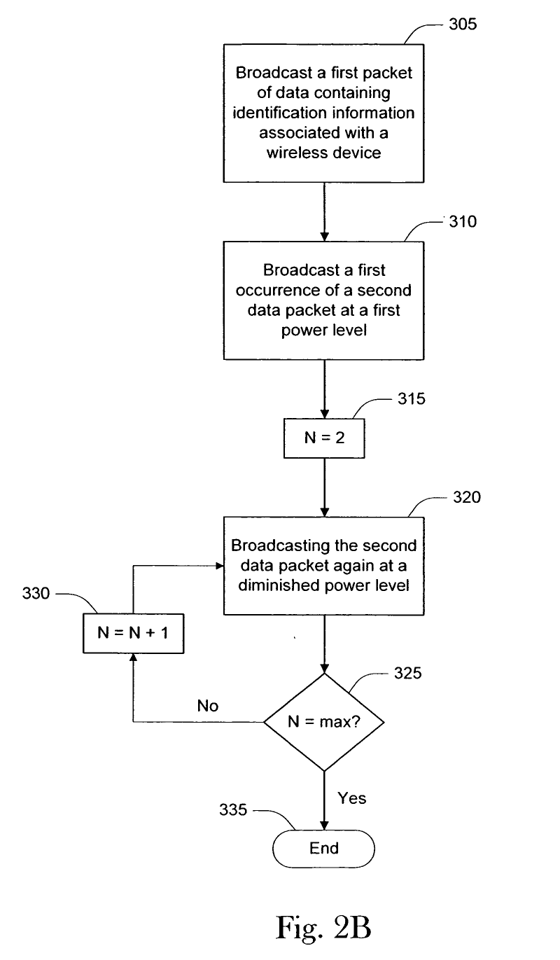

FIG. 2A is a flowchart for a method of operating a wireless device, in accordance with one embodiment of the invention. At 205, the wireless device broadcasts a first packet of data containing identification information associated with the wireless device. This broadcast may be a periodic or random broadcast. Alternatively, the broadcast may be in response to a query initiated by a client device seeking a suitable peripheral device. The first packet of data is preferably transmitted at a maximum power level associated with the device. At 210, the wireless device then broadcasts a first occurrence of a second data packet at a first power level. The first power level is preferably less than or equal to a power level utilized for transmitting the packet of data containing identification information. In this manner, a client device will generally not receive the second data packet unless it has first received the associated identification information. At 215, the wireless device then broadcasts a second occurrence of the second data packet at a second power level lower than the first power level.

To improve the differentiation between multiple transmitting devices, the occurrences of transmitting the second data packet may be repeated at additional power levels. FIG. 2B is a flowchart for a method of operating a wireless device, in accordance with another embodiment of the invention. At 305, the wireless device broadcasts a first packet of data containing identification information associated with the wireless device. At 310, the wireless device then broadcasts a first occurrence of a second data packet at a first power level. At 315, a counter is initiated. At 320, the wireless device then broadcasts the second data packet again at a diminished power level. The counter is checked at 325 to see if the desired occurrences have been transmitted. If the desired number of transmissions is reached, control is transferred to 335, where the process ends. If the desired number of transmissions has not yet been reached at 325, the counter is incremented at 330 and control returns to 320 for transmission of the second data packet at a diminished power level associated with the current count value.

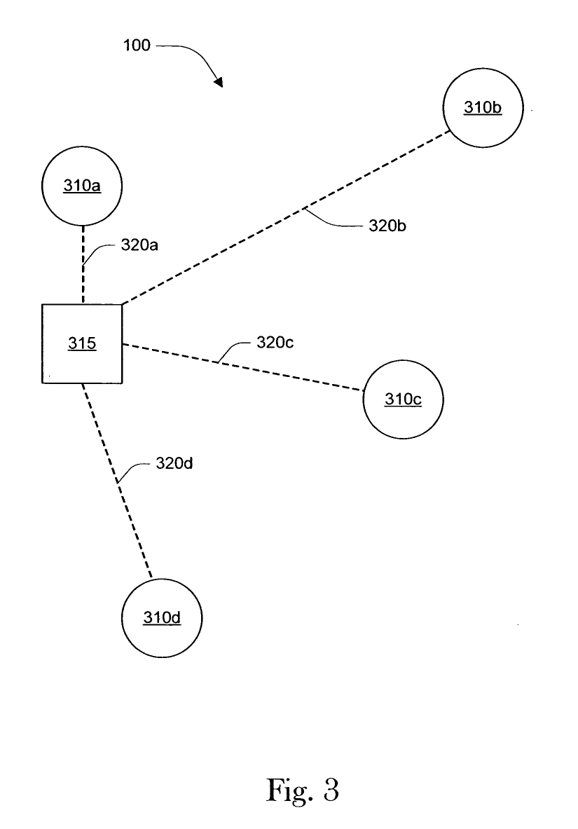

FIG. 3 is a schematic of a wireless network 300 containing one or more wireless network peripheral devices 310 (310a-310d) and a wireless network client device 315. One or more of the wireless peripheral devices 310 is adapted to perform methods of the invention and/or the wireless client device 315 is adapted to perform methods of the invention.

Wireless client device 315 is located a first distance 320a from wireless peripheral device 310a, a second distance 320b from wireless peripheral device 310b, a third distance 320c from wireless peripheral device 310c and a fourth distance 320d from wireless peripheral device 310d. For this example, distance 320a<<320c≈320d<<320b.

In conjunction with this example, let us presume that client device 315 is able to receive transmissions from wireless device 310a at power levels down to 10 mW, from wireless device 310b at power levels down to 300 mW and from wireless devices 310c and 310d at power levels down to 100 mW. As such, if each of the wireless devices 310a-310d transmits its identification information at 500 mW, client device 315 is presumed to be able to receive identification information from each of the wireless devices 310a-310d. If each of the wireless devices 310a-310d repeats a second sentence, for example, at power levels of 400 mW, 300 mW, 200 mW, 100 mW, 50 mW and 10 mW, client device 315 is expected to receive six occurrences of the sentence from wireless device 310a, two occurrences of the sentence from wireless device 310b and four occurrences of the sentence from each of the wireless devices 310c and 310d.

In this manner, client device 315 is able to rank the client devices by relative location, with wireless device 310a being closest and wireless device 310b being the most remote. Although the various embodiments presume the classical relationship between distance and signal strength, as described above, it is recognized that transmission obstacles and other interferences may result in lower signal efficiencies for various transmitting devices. However, for the purposes of the embodiments, it is presumed that receipt of additional occurrences of the repeated portion indicates improving signal strength, and closer proximity can be assumed.

While a simple ranking by relative distance can be made based on the number of occurrences of the repeated packet received at the client device from a single transmission set, signal quality may vary over time. To compensate for changes in signal quality, multiple sets can be monitored over time to develop an averaged rating. For example, a wireless device can be assigned a score on a scale of 0-100. If all occurrences of the repeated packet are received, e.g., six, an initial score of 85, for example, could be assigned. For each additional receipt of all six occurrences, the score could be increased by some quantity, e.g., 2. For receipts of less than all occurrences, the score could be decreased by some quantity. As an example, the score could be decreased by 2 for each occurrence not received. Modifying the score based on continued signal reliability can increase the ranking of peripheral devices having consistently good signal quality.

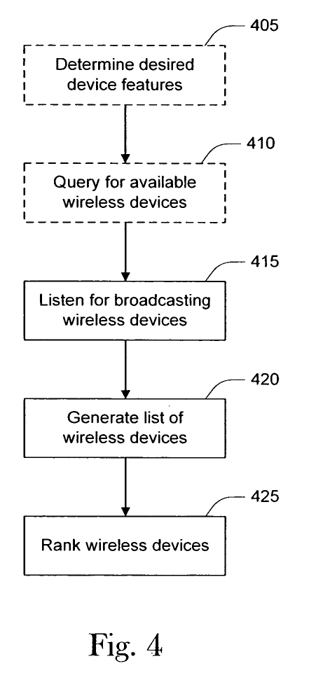

FIG. 4 is a flowchart for a method of operating a client device, such as a mobile computer or PDA. Optionally, at 405, the client device determines desired functionality. The determination may be automated, for example, based on a page setup of a document to be printed. Alternatively, the client device could query the user to determine what functionality the user would like to search for. However, the client device may proceed without knowing the desired functionality.

Optionally, at 410, the client device transmits a query for available devices. Querying would be necessary if the wireless peripheral devices do not periodically transmit data packets, in accordance with the invention, but only transmit such packets in response to a query, or request, from a client device. If the wireless peripheral devices transmit their packets automatically, no querying is necessary.

At 415, the client device listens for broadcasting devices. At 420, the client device then generates a list of wireless devices that it hears transmitting their identification information along with information concerning how many occurrences of the repeated packet are received from each such wireless device. At 425, the client device ranks the wireless devices in its list. If no desired functionality is available, the client device would rank on the basis of presumed proximity. If a desired functionality is available, the client device can further rank the listed wireless devices based on whether they provide the desired functionality. Optionally, the client device can eliminate any detected wireless device that does not provide the desired functionality such that any list presented to the user contains only those devices matching the desired functionality.

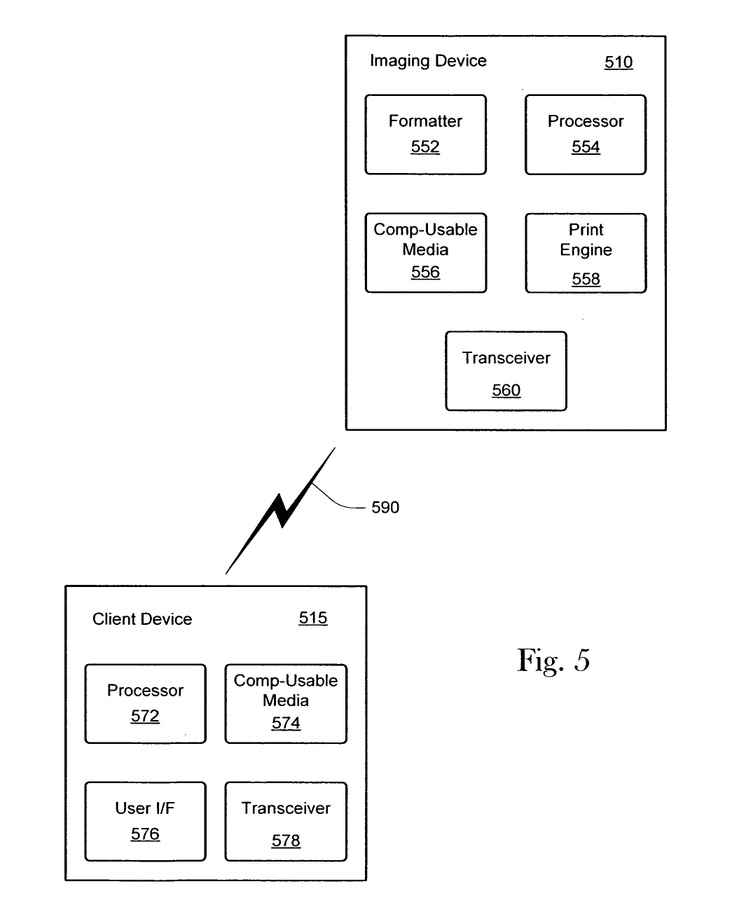

FIG. 5 is a block diagram of a wireless peripheral device, such as imaging device 510, and a client device 515, such as a mobile computer or PDA, in accordance with an embodiment of the invention. The imaging device 510 has a formatter 552 for interpreting image data, such as might be received from the client device 515, and rendering the image data into a printable image. The imaging device 510 further includes a processor 554 and computer-usable media 556 coupled to the processor 554. The formatter 552 provides the processed image page description, in the form of a printable image, to a print engine 558 to produce a tangible output image representative of the image data. The print engine 558 represents the mechanical aspects of the imaging device 510.

The client device 515 includes a processor 572 and a computer-usable media 574 in communication with the processor 572. The client device 515 further includes a user interface 576 for displaying lists of discovered peripheral devices, and allowing selection of a listed device, in accordance with embodiments of the invention. The client device 510 may be coupled to the imaging device 510 through a wireless communication link 590. Communications link 590 is generally a bidirectional communication link between transceiver 560 of the imaging device 510 and transceiver 578 of the client device 515. Transceivers 560 and 578, in conjunction with their processors 554 and 572, respectively, are generally capable of concurrent communication with multiple external devices. The transceiver 560 transmits the data packets, in accordance with the invention, in response to its processor 554. The transceiver 578 receives the data packets from broadcasting peripheral devices, such as imaging device 510, for discovering the peripheral devices in accordance with the invention.

The processors 554 and/or 572 are adapted to perform methods in accordance with embodiments of the invention in response to computer-readable instructions. These computer-readable instructions are stored on the computer-usable media 556 or 574, respectively, and may be in the form of either software, firmware or hardware. In a hardware solution, the instructions are hard coded as part of a processor, e.g., an application-specific integrated circuit (ASIC) chip. In a software or firmware solution, the instructions are stored for retrieval by the processor. Some additional examples of computer-usable media include static or dynamic random access memory (SRAM or DRAM), read-only memory (ROM), electrically-erasable programmable ROM (EEPROM), magnetic media and optical media, whether permanent or removable. Most consumer-oriented computer applications are software solutions provided to the user on some removable computer-usable media, such as a compact disc read-only memory (CD-ROM).

### CONCLUSION

Methods and apparatus for identifying and ranking wireless peripheral devices have been described herein utilizing beacons of diminishing signal strength. Signal strength in a wireless network is indicative of a distance between a transmitting device and a receiving device. By repeatedly transmitting a packet of information from wireless peripheral devices at decreasing signal strengths, and monitoring how many occurrences of the packet are received at a client device from each peripheral device, the client device can rank peripheral devices based at least upon presumed proximity. By knowing the relative proximity of multiple resource devices and their functionalities, a user can make a better-informed decision as to which resource to utilize.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. For example, the wireless peripheral could be a network access point. By broadcasting a beacon, in accordance with the invention, from a plurality of network access points, a client device could make an informed decision regarding which access point to utilize to facilitate the highest quality connection, i.e., a connection with the least likelihood of disruption of service. Accordingly, this application is intended to cover any such adaptations or variations of the invention. It is manifestly intended that this invention be limited only by the following claims and equivalents thereof.

1. A method for discovering a wireless device on a computer network, the method comprising:
broadcasting from the wireless device a first data packet containing identification information associated with the wireless device, wherein the identification information contains at least a location and a functionality of the wireless device; and
broadcasting from the wireless device a second data packet a plurality of times, wherein a first occurrence of the second data packet is broadcast at a first power level and a second occurrence of the second data packet is broadcast at a second power level lower than the first power level.

2. The method of claim 1, wherein broadcasting is in response to a query received from an external device.

3. The method of claim 1, wherein the wireless device is an imaging device.

4. The method of claim 1, wherein the identification information further contains a device description and necessary permissions.

5. The method of claim 1, wherein the first data packet further contains a checksum for error checking.

6. The method of claim 1, wherein the first power level is lower than a power level used to broadcast the first data packet.

7. The method of claim 6, wherein the power level used to broadcast the first data packet is a maximum power level for the wireless device.

8. The method of claim 1, wherein a third occurrence of the second data packet is broadcast at a third power level lower than the second power level, a fourth occurrence of the second data packet is broadcast at a fourth power level lower than the third power level, a fifth occurrence of the second data packet is broadcast at a fifth power level lower than the fourth power level, and a sixth occurrence of the second data packet is broadcast at a sixth power level lower than the fifth power level.

9. The method of claim 8, wherein the first power level is approximately 400 mW, the second power level is approximately 300 mW, the third power level is approximately 200 mW, the fourth power level is approximately 100 mW, the fifth power level is approximately 50 mW and the sixth power level is approximately 10 mW.

10. A method for discovering a wireless device on a computer network, the method comprising:
broadcasting from the wireless device a first data packet containing identification information associated with the wireless device, wherein the identification information contains at least a location and a functionality of the wireless device; and
broadcasting from the wireless device a second data packet a plurality of times, wherein the second data packet is broadcast at more than one power level.

11. The method of claim 10, wherein each occurrence of the second data packet is broadcast at a power level lower than a power level used for a prior occurrence.

12. The method of claim 10, wherein the first data packet further contains an indication of a number of times the second data packet will be broadcast and a power level for each occurrence of the second data packet.

13. The method of claim 10, wherein each occurrence of the second data packet contains an indication of the power level used to broadcast that occurrence.

14. A method for discovering a wireless device on a computer network, the method comprising:
broadcasting from the wireless device a first data packet containing identification information associated with the wireless device, wherein the identification information contains at least a location and a functionality of the wireless device; and
broadcasting from the wireless device a second data packet a predetermined number of times at diminishing power levels.

15. A wireless device, comprising:
a processor;
a transceiver coupled to the processor; and
a computer-usable media containing computer-readable instructions adapted to cause the processor to perform a method, the method comprising:
causing the transceiver to broadcast a first data packet containing identification information associated with the wireless device, wherein the identification information contains at least a location and a functionality of the wireless device; and
after broadcasting the first data packet, causing the transceiver to broadcast a first occurrence of second data packet at a first power level and to broadcast a second occurrence of the second data packet at a second power level lower than the first power level.

16. The wireless device of claim 15, wherein the computer-readable instructions are further adapted to cause the processor to cause the transceiver to broadcast the first data packet in response to receiving a query at the transceiver.

17. The wireless device of claim 15, wherein the computer-readable instructions are further adapted to cause the processor to cause the transceiver to broadcast the first data packet periodically.

18. The wireless device of claim 15, wherein the wireless device is an imaging device, further comprising a formatter for rendering image data into a printable image and a print engine for converting the printable image into a tangible image.

19. The wireless device of claim 15, wherein the identification information further contains a device description and necessary permissions.

20. The wireless device of claim 15, wherein the first data packet further contains a checksum for error checking.

21. The wireless device of claim 15, wherein the first power level is lower than a power level used for broadcasting the first data packet.

22. The wireless device of claim 21, wherein the power level used for broadcasting the first data packet is a maximum power level for the wireless device.

23. The wireless device of claim 15, wherein a third occurrence of the second data packet is broadcast at a third power level lower than the second power level, a fourth occurrence of the second data packet is broadcast at a fourth power level lower than the third power level, a fifth occurrence of the second data packet is broadcast at a fifth power level lower than the fourth power level, and a sixth occurrence of the second data packet is broadcast at a sixth power level lower than the fifth power level.

24. The wireless device of claim 23, wherein the first power level is approximately 400 mW, the second power level is approximately 300 mW, the third power level is approximately 200 mW, the fourth power level is approximately 100 mW, the fifth power level is approximately 50 mW and the sixth power level is approximately 10 mW.

25. A wireless peripheral device, comprising:
a processor;
a transceiver coupled to the processor; and
a computer-usable media containing computer-readable instructions adapted to cause the processor to perform a method, the method comprising:
causing the transceiver to broadcast a first data packet containing identification information associated with the wireless peripheral device; and
after broadcasting the first data packet, causing the transceiver to broadcast a second data packet a predetermined number of times at diminishing power levels.

26. A wireless imaging device, comprising:
a processor;
a formatter coupled to the processor;
a print engine coupled to the formatter; and
a transceiver coupled to the processor, wherein the transceiver is adapted to transmit a first data packet at an initial power level, the first data packet containing identification information associated with the imaging device, and to transmit a second data packet a plurality of times at diminishing power levels.

27. A method of choosing a peripheral device on a wireless computer network containing a plurality of peripheral devices, the method comprising:
receiving one or more first data packets, wherein each of the first data packets contains identification information associated with a peripheral device;
in response to receiving a first data packet from a peripheral device, listening for a second data packet and counting a number of times the second data packet is received from that peripheral device;
ranking the plurality of peripheral devices based at least in part on the number of times the second data packet is counted for each peripheral device.

28. The method of claim 27, further comprising:
modifying the ranking based at least in part on continued monitoring of signal reliability from each of the peripheral devices.

29. The method of claim 28, wherein modifying the ranking further comprises assigning an initial score based on a number of times the second data packet is counted for a peripheral device, increasing the score if a maximum number of second data packets is counted for that peripheral device and decreasing the score if less than a maximum number of second data packets is counted for that peripheral device.

30. The method of claim 27, further comprising:
broadcasting a query to request the first data packets.

31. The method of claim 27, further comprising:
determining a desired functionality for a peripheral device to be chosen;
obtaining information indicative of the functionality of each peripheral device from their respective first data packets; and
eliminating any peripheral device not containing the desired functionality.

32. The method of claim 31, further comprising:
further ranking the plurality of peripheral devices based in part on their functionality.

33. The method of claim 27, further comprising:
obtaining information indicative of a functionality of each peripheral device from their respective first data packets; and
further ranking the plurality of peripheral devices based in part on their functionality.

34. A method of choosing a peripheral device on a wireless computer network containing a plurality of peripheral devices, the method comprising:
receiving one or more first data packets, wherein each of the first data packets contains identification information associated with a peripheral device and wherein each of the first data packets further contains information about a number of times a second data packet will be transmitted and a power level for each such transmission;
in response to receiving a first data packet, listening for the second data packet and determining a lowest power level at which the second data packet is received;
ranking the plurality of peripheral devices based at least in part on the lowest power level at which the second data packet is received for each peripheral device.

35. An imaging device, comprising:
means for rendering image data and providing a tangible output representative of the image data;
means for broadcasting a first data packet containing identification information associated with the imaging device; and
means for broadcasting a second data packet a plurality of times, wherein the
means for broadcasting the second data packet is adapted to broadcast the occurrences of the second data packet at diminishing power levels.

36. The imaging device of claim 35, wherein each occurrence of the second data packet contains an indication of a power level used to broadcast that occurrence.
